(19) United States
(12) Patent Application Publication
(10) Pub. No.: US 2025/0058508 A1
(43) Pub. Date: Feb. 20, 2025

(54) INFORMATION PROCESSING SYSTEM, NON-TRANSITORY COMPUTER READABLE MEDIUM STORING PROGRAM, AND MANUFACTURING METHOD OF INJECTION MOLDING MACHINE

(71) Applicant: SUMITOMO HEAVY INDUSTRIES, LTD., Tokyo (JP)

(72) Inventors: Yuki MATSUI, Chiba-shi (JP); Daigo HOTTA, Chiba-shi (JP)

(21) Appl. No.: 18/661,669

(22) Filed: May 12, 2024

(30) Foreign Application Priority Data
Aug. 14, 2023 (JP) 2023-131974

(51) Int. Cl. B29C 45/76; B29C 45/77

(52) U.S. Cl. CPC B29C 45/7653; B29C 45/77; B29C 2945/7613; B29C 2945/76287; B29C 2945/76381; B29C 2945/76454; B29C 2945/76605

(57) ABSTRACT

An information processing system includes: an acquisition unit that acquires waveform data obtained through an operation of control target equipment; an analysis unit that extracts, based on a relationship of variables included in the acquired waveform data, a first variable that is at least a portion of the variables and a second variable that is at least another portion of the variables, that derives variables corresponding to the second variables based on the first variable, and that defines characteristics of the control target equipment based on the derived variables and the second variable; and an output unit that outputs information used in controlling the control target equipment based on the characteristics of the control target equipment.

### CROSS-REFERENCE TO RELATED APPLICATIONS

This application claims priority to Japanese Patent Application No. 2023-131974, filed on Aug. 14, 2023, which is incorporated by reference herein in its entirety.

### BACKGROUND

### Technical Field

A certain embodiment of the present invention relates to an information processing system, a non-transitory computer readable medium storing a program, and a manufacturing method of an injection molding machine.

### Description of Related Art

A control gain such as a proportional-integral (PI) control gain is used for controlling equipment. The response of a control target is determined by the control gain and the characteristics of the control target. Therefore, the control gain can be calculated in reverse when the characteristics of the equipment, which is a control target, and the desired response are determined.

The related art discloses a control system including: a state observation unit that observes information related to a machine as state data; a determination data acquisition unit that acquires information related to processing as determination data; a reward calculation unit that calculates reward based on the determination data and a reward condition; a learning unit that performs machine learning for adjustment of a servo gain of the machine; a decision-making unit that determines an action of the adjustment of the servo gain of the machine based on a machine learning result of the adjustment of the servo gain of the machine and the state data; and a gain change unit that changes the servo gain of the machine based on the determined action of the adjustment of the servo gain.

### SUMMARY

According to an embodiment of the present invention, there is provided an information processing system including: an acquisition unit that acquires waveform data obtained through an operation of control target equipment; an analysis unit that extracts, based on a relationship of variables included in the acquired waveform data, a first variable that is at least a portion of the variables and a second variable that is at least another portion of the variables, that derives variables corresponding to the second variables based on the first variable, and that defines characteristics of the control target equipment based on the derived variables and the second variable; and an output unit that outputs information used in controlling the control target equipment based on the characteristics of the control target equipment.

### BRIEF DESCRIPTION OF THE DRAWINGS

FIG. 1 is a diagram showing a configuration of an injection molding machine according to an embodiment of the present invention.

FIG. 2 is a diagram showing a configuration of a control device.

FIG. 3 is a diagram showing a configuration of a data processing device.

FIG. 4 is a diagram showing a configuration of an information processing device.

FIG. 5 is a diagram showing a hardware configuration example of a computer that implements the information processing device.

FIGS. 6A and 6B are diagrams schematically showing adjustment of a machine difference, FIG. 6A is a diagram showing an example of the machine difference, and FIG. 6B is a diagram showing a state in which the machine difference is adjusted.

FIG. 7 is a diagram showing a configuration of a linear multiple regression model.

FIG. 8 is a diagram showing an example of an analysis process performed by an analysis unit.

FIG. 9 is a flowchart showing a procedure for adjusting control information according to characteristics of equipment in the injection molding machine.

### DETAILED DESCRIPTION

Although physical quantities detected in equipment have a relationship with each other, there is a physical quantity in which the relationship varies (a machine difference) for each equipment. When such a machine difference exists, even when the control is performed by the same control gain, the response to the control is different for each equipment.

It is desirable to provide information for reducing a difference in operation of equipment due to a machine difference by defining characteristics of a control target in a relationship of physical quantities of the equipment and implementing control according to the characteristics for each equipment.

Hereinafter, embodiments of the present invention will be described in detail with reference to the accompanying drawings.

### Device Configuration

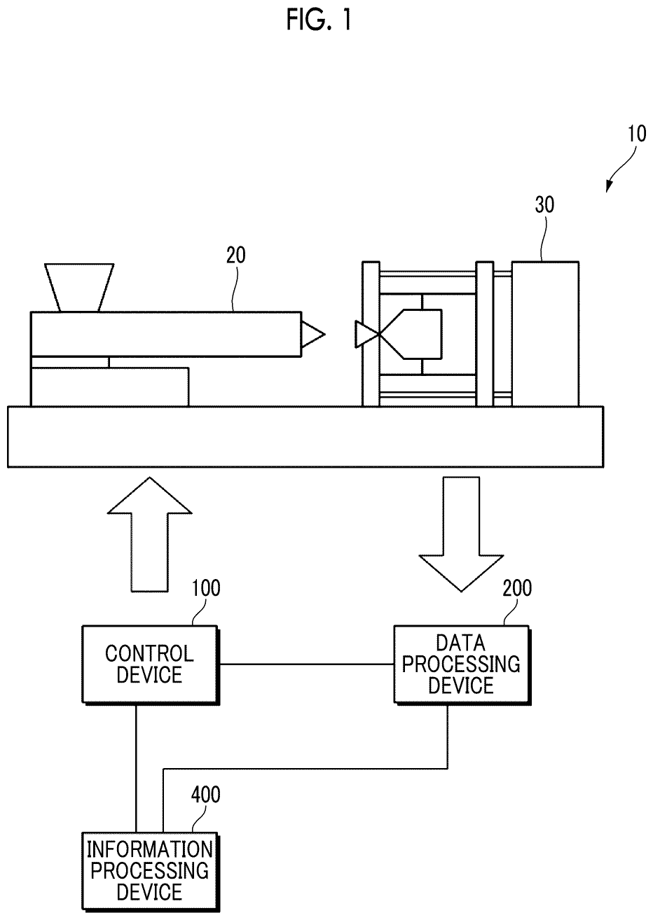

FIG. 1 is a diagram showing a configuration of an injection molding machine to which the present embodiment is applied. An injection molding machine 10 includes an injection unit 20, a mold clamping unit 30, a control device 100, and a data processing device 200. The injection molding machine 10 is an example of control target equipment. In addition, an information processing device 400 is connected to the control device 100 and the data processing device 200.

The injection unit 20 is configured to include a cylinder that heats a molding material, a screw that is rotatable in the cylinder and is provided to be able to advance and retreat in an axial direction, a rotary motor that drives the screw in a rotation direction, a motor that drives the screw in the axial direction, and the like. The molding material is, for example, a resin. The injection unit 20 injects the molding material, which is heated and liquefied in the cylinder, by advancing the screw in a direction (front) toward the mold clamping unit 30 from the injection unit 20 while rotating the screw and fills a die of the mold clamping unit 30, which is disposed in front of the injection unit 20, with the molding material. The injection unit 20 performs, for example, a plasticizing process, a filling process, a pressure holding process, or the like in a manufacturing process of a molding product. The filling process and the pressure holding process may be collectively referred to as an injection process.

The mold clamping unit 30 is configured to include a die, a clamping mechanism that clamps the die, and a motor that drives the clamping mechanism. The mold clamping unit 30 closes the die to receive the molding material, which is injected from the injection unit 20, into the die. In this case, the mold clamping unit 30 clamps the die with the clamping mechanism such that the die does not open as the die is filled with the molding material (mold clamping). A molding product is produced by solidifying the molding material that fills the die. After this, the mold clamping unit 30 opens the die, and the generated molding product can be taken out. The mold clamping unit 30 performs, for example, a mold closing process, a pressurizing process, a mold clamping process, a depressurizing process, a mold opening process, or the like in the manufacturing process of the molding product.

The control device 100 is a device that controls operations of the injection unit 20 and the mold clamping unit 30. The data processing device 200 is a device that processes data obtained as the injection unit 20 and the mold clamping unit 30 are operated.

The information processing device 400 acquires waveform data obtained through an operation of the injection molding machine 10 from the control device 100 and the data processing device 200, and defines characteristics of the injection molding machine 10 based on the acquired waveform data. The characteristics include an element that causes a machine difference between the individual injection molding machines 10. The information processing device 400 outputs information for performing control to reduce the machine differences between the individual injection molding machines 10 based on information on the defined characteristics of the injection molding machines 10 and provides the information to the control device 100. Details of the information processed and output by the information processing device 400 will be described later.

### Configuration of Control Device 100

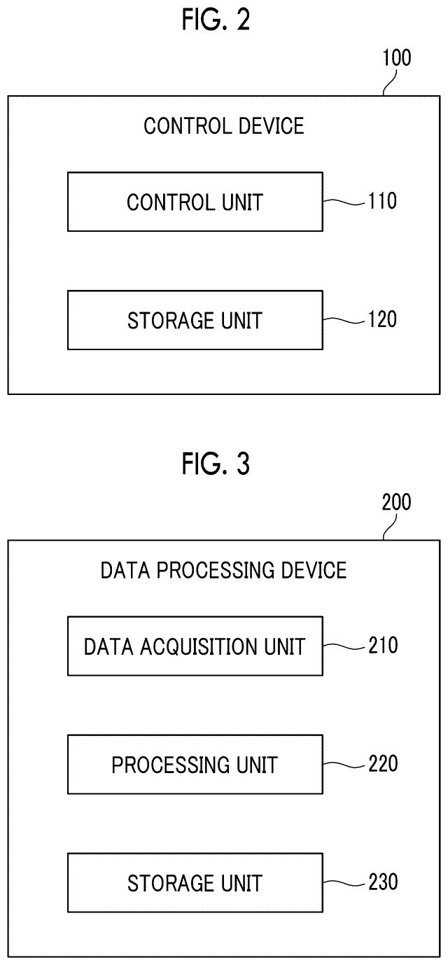

FIG. 2 is a diagram showing a configuration of the control device 100. The control device 100 controls the operations of the injection unit 20 and the mold clamping unit 30. The control device 100 is implemented by, for example, a computer. The control device 100 includes a control unit 110 and a storage unit 120. The control device 100 controls the injection unit 20 and the mold clamping unit 30 to repeatedly perform processes related to the manufacture of the molding product, thereby repeatedly manufacturing the molding product. The process related to the manufacture of the molding product includes a plasticizing process, a mold closing process, a pressurizing process, a mold clamping process, a filling process, a pressure holding process, a cooling process, a depressurizing process, a mold opening process, an ejection process, and the like. Hereinafter, these processes related to the manufacture may be collectively referred to as a “manufacturing process”. In addition, a series of operations for obtaining the molding product, for example, an operation from a start of the plasticizing process to a start of the next plasticizing process in the above manufacturing process is referred to as a “shot” or a “molding cycle”. Each of the above-described processes for manufacturing the molding product is merely an example. For example, as a process executed in one shot, another process, which is not included in the above, may be included.

The control unit 110 controls the injection unit 20 and the mold clamping unit 30 based on control information. The control information is a condition set by the user and is generated based on the information input from the user using, for example, an input device (not shown). For example, the control information includes molding conditions such as resin temperature, die temperature (cylinder temperature), injection pressure holding time, metering value, V-P switching position, holding pressure, injection speed (filling speed), screw rotating speed, screw back pressure, and mold clamping force. A plurality of combinations of these molding conditions are determined according to the molding product or the die. Hereinafter, combination data of the molding conditions will be also referred to as a molding condition data set. In addition, the control information includes control data such as a voltage, a current, a pressure, a speed, and an acceleration with respect to a drive unit such as a mechanism or a motor. The molding condition data set is prepared in accordance with the type of the molding product or the die and is stored in the storage unit 120.

The control unit 110 controls the injection unit 20 and the mold clamping unit 30 by using the above-described molding condition data set and performs a process related to the manufacture (shot) of the molding product that includes each of the above-described processes. The control unit 110 reads the molding condition data set corresponding to the molding product to be manufactured from the storage unit 120, for example, when the manufacture of the molding product starts. The control unit 110 controls the operations of the injection unit 20 and the mold clamping unit 30 based on the control information including the read molding condition data set. Specifically, the control unit 110 controls the injection unit 20 and the mold clamping unit 30 such that the data, which is obtained from the injection unit 20 and the mold clamping unit 30 in the manufacturing process, matches a set value of the molding condition data set.

The storage unit 120 stores the control information used for controlling the injection unit 20 and the mold clamping unit 30 via the control unit 110. The molding condition data set, which is included in the control information, is prepared to be associated with the molding product to be manufactured or the die. The storage unit 120 stores the molding condition data set for each molding product to be manufactured or each die. In addition, although not shown, the storage unit 120 stores a program for the control unit 110 to control the injection unit 20 and the mold clamping unit 30. As will be described in detail later, functions of the control unit 110 are implemented by a processor of the control device 100 reading and executing the program stored in the storage unit 120.

### Configuration of Data Processing Device 200

FIG. 3 is a diagram showing a configuration of the data processing device 200. The data processing device 200 acquires and processes data obtained as the injection unit 20 and the mold clamping unit 30 execute operations in a process related to the manufacture of the molding product. The data processing device 200 is implemented by, for example, a computer. The data processing device 200 includes a data acquisition unit 210, a processing unit 220, and a storage unit 230.

The data acquisition unit 210 acquires data to be processed from the injection unit 20 and the mold clamping unit 30. Various sensors, detectors, and the like are attached to the injection unit 20 and the mold clamping unit 30. In addition, various types of measuring equipment may be connected to the injection unit 20 or the mold clamping unit 30. The data (hereinafter, referred to as “acquisition data”), which is acquired by using these sensors, detectors, and measuring equipment, is information representing a molding result obtained by the injection unit 20 and the mold clamping unit 30 and is used for quality management of the molding product. The data acquisition unit 210 receives the acquisition data, which is transmitted from the sensor, the detector, the measuring equipment, or the like, and stores the acquisition data in the storage unit 230.

The processing unit 220 processes the acquisition data stored in the storage unit 230. Specifically, the processing unit 220 performs a process such as extracting a representative value of the acquisition data obtained in each process and generating time-series data in which time series is associated with the acquisition data obtained in each process. In extracting the representative value, the processing unit 220 performs a statistical process such as calculating an average value, specifying a possible range of values, and specifying a maximum value or a minimum value with respect to the acquisition data.

The storage unit 230 stores the acquisition data that is acquired by the data acquisition unit 210. As a data format of the acquisition data stored in the storage unit 230, for example, binary, text, comma-separated values (CSV), INI, YAML Ain′t Markup Language (YAML), JavaScript Object Notation (JSON), or the like may be used. By creating data files in these general-purpose data formats, a data file that is stored in the storage unit 230 can be data-exchanged with other information processing devices, and a data file that is acquired from an external device can be edited. In addition, although not shown, the storage unit 230 stores a program for the processing unit 220 to execute data processing. As will be described in detail later, functions of the processing unit 220 are implemented by a processor of the data processing device 200 reading and executing the program stored in the storage unit 230.

### Configuration of Information Processing Device 400

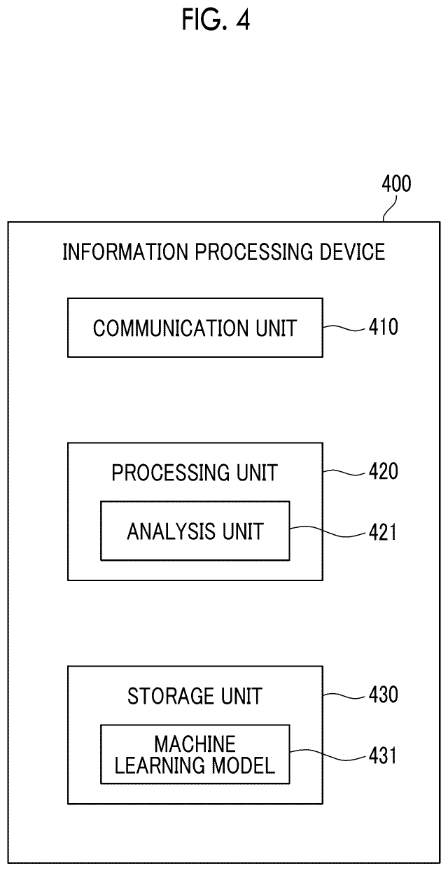

FIG. 4 is a diagram showing a configuration of the information processing device 400. The information processing device 400 acquires the waveform data obtained through the operation of the injection molding machine 10 to define the characteristics of the injection molding machine 10 and outputs the information used in controlling the injection molding machine 10 based on the defined information on the characteristics. The information processing device 400 is implemented by, for example, a computer. The information processing device 400 includes a communication unit 410, a processing unit 420, and a storage unit 430. The processing unit 420 includes an analysis unit 421 that analyzes the characteristics of the injection molding machine 10 by using a machine learning model. The storage unit 430 stores a machine learning model 431 used for the analysis by the analysis unit 421.

The communication unit 410 receives the waveform data obtained through the operation of the injection molding machine 10 from the control device 100 and the data processing device 200. The data to be received may be various types of data obtained as the waveform data at the time of the operation of the injection molding machine 10. Specifically, for example, data such as a voltage and a current supplied to various mechanisms, and a speed, an acceleration, and a pressure in an operation of various mechanisms can be given. In addition, the communication unit 410 transmits the information, which is used in controlling the injection molding machine 10 obtained through the processing of the processing unit 420, to the control device 100. The communication unit is an example of an acquisition unit.

The processing unit 420 performs processing of defining the characteristics of the injection molding machine 10 by using the waveform data received by the communication unit 410. The processing unit 420 extracts, from the acquired waveform data, an input variable to be input to the machine learning model and an actual value to be used for verification and inputs the input variable and the actual value to the analysis unit 421. The input variable is an example of a first variable, and the actual value is an example of a second variable. Here, the input variable and the actual value are variables having a relationship with each other. That is, when a value of the input variable changes, a value of the actual value also changes in response to the change. In addition, the processing unit 420 outputs the information for controlling the injection molding machine 10 based on an analysis result obtained by the analysis unit 421 and causes the communication unit 410 to transmit the information to the control device 100. The processing unit 420 is an example of an output unit.

The analysis unit 421 inputs the input variable to the machine learning model 431 from among the input variables and the actual values input, and derives a variable corresponding to the actual value (hereinafter, referred to as an “output value”). The analysis unit 421 is an example of a machine learning device. Next, the analysis unit 421 compares the actual value with the output value, and calculates an error. The analysis unit 421 adjusts the machine learning model 431 such that the error of the output value with respect to the actual value becomes smaller. Details of the processing of the analysis unit 421 and the machine learning model 431 will be described later.

The storage unit 430 stores the waveform data received by the communication unit 410, the information obtained through the processing of the processing unit 420, the machine learning model 431 used by the analysis unit 421 of the processing unit 420, and the like. As a data format of a data file stored in the storage unit 430, for example, a CSV, an extensible markup language (XML), a JSON, or the like can be used.

### Hardware Configuration of Information Processing Device 400

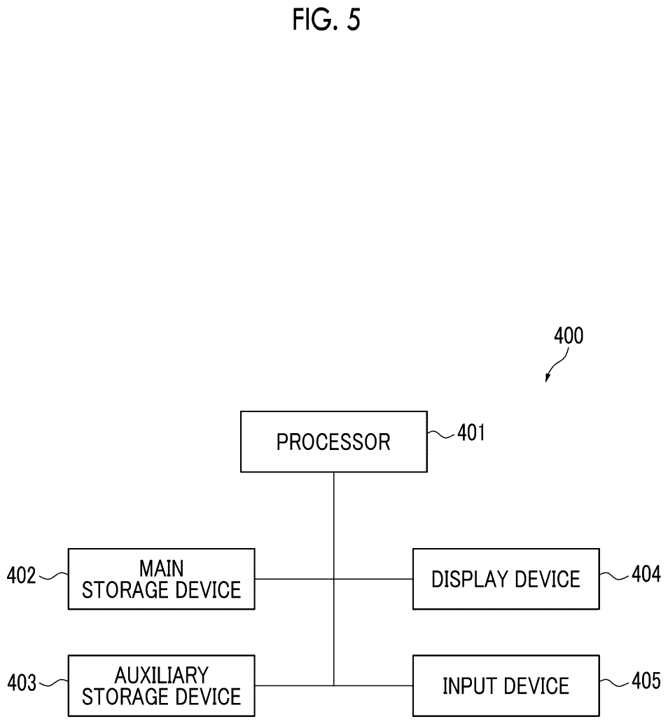

FIG. 5 is a diagram showing a hardware configuration example of the computer that implements the information processing device 400. The computer shown in FIG. 5 includes a processor 401 as a calculation unit, and a main storage device (a main memory) 402 and an auxiliary storage device 403 as storage units. For example, as the processor 401, a central processing unit (CPU), a graphics processing unit (GPU), an application-specific integrated circuit (ASIC), a field-programmable gate array (FPGA), or various other calculation circuits can be used. The processor 401 reads a program, which is stored in the auxiliary storage device 403, into the main storage device 402 and executes the program. For example, a random-access memory (RAM) is used as the main storage device 402. For example, a magnetic disk device, a solid-state drive (SSD), or the like is used as the auxiliary storage device 403.

In addition, the computer may be configured to include a display device 404 for displaying an image and an input device 405 as an input unit for an input operation of the computer performed by the user. As the input device 405, for example, a keyboard, a mouse, a touch panel, or the like is used. When a touch panel, which is configured integrally with the display device 404, is used as the input device 405, the user performs an input operation by touching an operation screen displayed on the display device 404 with a finger or a pen-type device. In addition, the configuration of the computer shown in FIG. 5 is merely an example, and the computer that is used in the present embodiment is not limited to the configuration example in FIG. 5. For example, a non-volatile memory such as a flash memory or a read-only memory (ROM) may be provided as the storage device.

When the information processing device 400 is implemented by the computer shown in FIG. 5, the communication unit 410 is implemented by, for example, a processor 401 that reads and executes a program and a communication interface (not shown). The function of the processing unit 420 is implemented, for example, by the processor 401 reading and executing a program. For example, the storage unit 430 is implemented by the auxiliary storage device 403.

### Machine Difference of Control Target Equipment

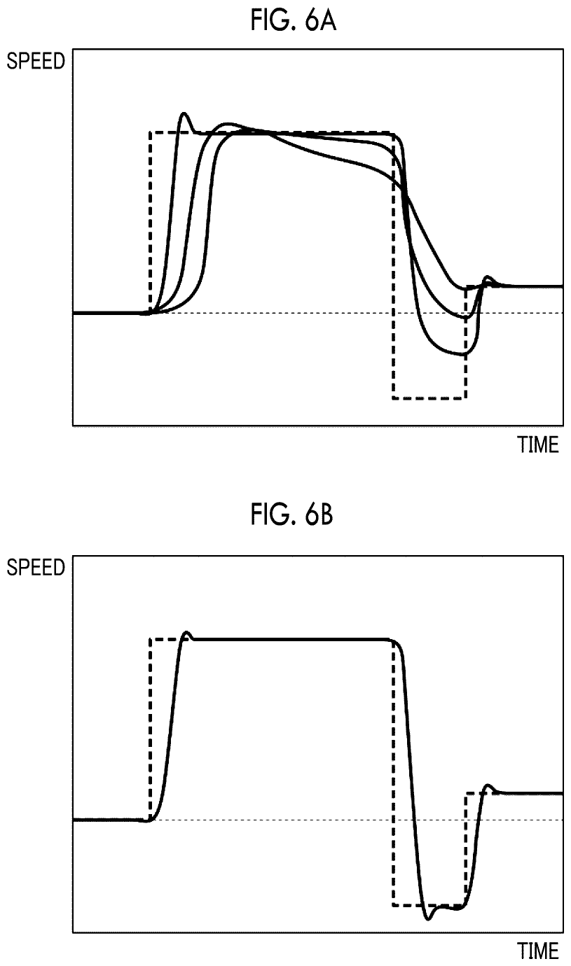

FIGS. 6A and 6B are diagrams schematically showing adjustment of a machine difference, FIG. 6A is a diagram showing an example of the machine difference, and FIG. 6B is a diagram showing a state in which the machine difference is adjusted. FIGS. 6A and 6B are waveform diagrams in which a vertical axis represents speed and a horizontal axis represents time, when an operation speed of the control target equipment changes over time. FIGS. 6A and 6B are waveform diagrams in which a broken line indicates control information and a solid line indicates actual data.

Even when equipment such as the injection molding machines 10 are the same model, there are usually some machine differences between the equipment, resulting in differences in operation. For example, a consideration is made in which the speed is controlled as shown in FIGS. 6A and 6B by changing a current value of the motor. In this case, even in a case where the current value of the motor can be controlled to be a desired state, when there is a machine difference, the speed obtained in each equipment varies as shown in FIG. 6A. Even when the desired speed is finally reached by detecting the speed or position with a sensor, applying feedback, and controlling the current value, the time lag and overshoot that occur until reaching the desired speed vary depending on the machine difference. In the example shown in FIG. 6A, speed changes (solid lines) in three pieces of equipment controlled according to one piece of control information (broken line) are shown. In the example shown in FIG. 6A, the three pieces of equipment show different speed changes while being controlled by the same control information.

In the present embodiment, such machine differences are handled as characteristics for each equipment, and by controlling the current value of the motor to reduce the machine difference, speed control in which a machine difference is reduced is implemented. In the example shown in FIG. 6B, the speed changes in the three pieces of equipment are shown in accordance with the same control information (broken line) as in the example shown in FIG. 6A. In the example shown in FIG. 6B, the machine difference between the three pieces of equipment is reduced, and the same speed change is shown by control based on the same control information.

Here, although a relation between the current value and the speed has been described as an example, the application scope of the present embodiment is not limited to the above example. In some equipment, physical quantities detected using sensors or the like have a relationship with each other. The present embodiment can be applied to physical quantities, which are physical quantities having such a relationship, of which a relationship varies depending on the equipment. For example, a relationship between a current and a voltage, or a relationship between a speed and an acceleration can be given. In the relationship between the current and the voltage, since there is a machine difference in electrical resistance, even when the same current flows, a voltage value obtained may differ depending on the equipment. In addition, in the relationship between the speed and the acceleration, since there is a machine difference in inertia of a member of the equipment to be operated, even when the operation is made at the same speed, the acceleration may differ depending on the equipment. Regarding various physical quantities in these control target equipment, it is possible to reduce a machine difference between equipment and to implement control of causing each equipment to perform the same operation by applying the present embodiment.

The information processing device 400 analyzes the waveform data of the physical quantities having a relationship with each other as described with reference to FIGS. 6A and 6B and specifies the characteristics for each injection molding machine 10, which is the control target equipment. The information for performing control according to the characteristics for each injection molding machine 10 is generated, and the information is provided to the control device 100. As an analysis unit for the waveform data, the processing unit 420 of the information processing device 400 uses the machine learning model 431. For example, a linear multiple regression model can be used as the machine learning model 431.

In addition to the linear multiple regression model, a linear regression model or the other mathematical models can be used as the analysis unit for the waveform data. However, by using the linear multiple regression model, a learning model is easily built as compared with other units. This is because the waveform data has a plurality of variables, collection of correct data that is related to input and output is possible, and data that can be a plurality of input variables included in the waveform data is data that can be respectively expressed using four arithmetic operations (including those expressed by approximate calculation formulas). For this reason, it can be said that the analysis of the waveform data is compatible with the characteristics of supervised machine learning for the linear multiple regression model. In this manner, an operation of acquiring training data by operating the machine using a test device, of building a machine learning model by performing training, and of determining parameters through calculation using the built machine learning model can be performed in an extremely short time compared to manually adjusting various parameters such as voltage and current speed.

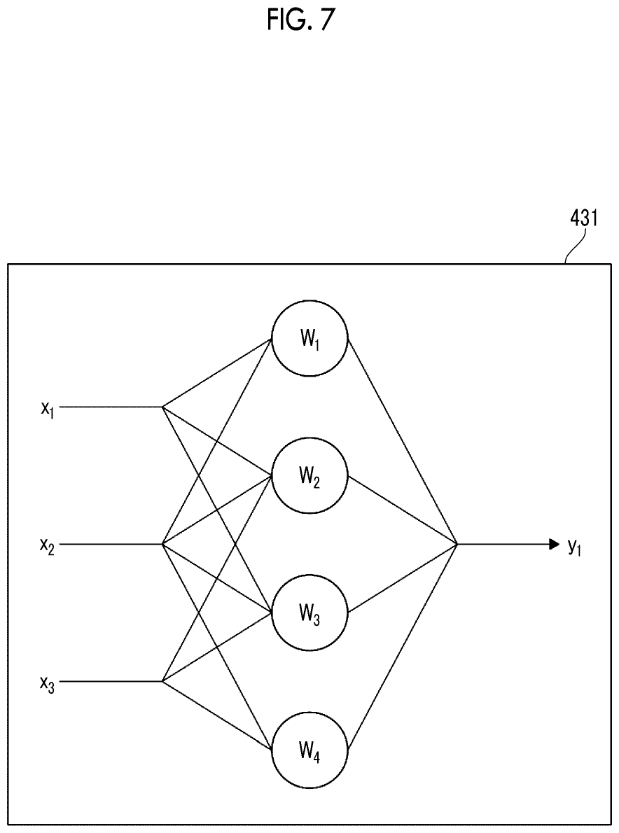

FIG. 7 is a diagram showing a configuration of the linear multiple regression model. The linear multiple regression model, which is used for the machine learning model 431, receives a plurality of inputs, performs an analysis in consideration of a correlation of each input through a plurality of nodes representing a plurality of processing units, and obtains a single output. In a model shown in FIGS. 7, x₁ to x₃ are input variables, and y₁ is an output. Here, w₁ to w₄, which are written in each node in the intermediate layer, represent weight values set in each node. That is, in the model shown in FIG. 7, when the input variables x₁ to x₃ are given, the output y₁ is obtained through processing using the weight values w₁ to w₄ in each node. By changing the weight values w₁ to w₄ of each node, different outputs y₁ are obtained for the same input variables x₁ to x₃. The number of input variables and nodes shown in FIG. 7 is merely an example and is not limited to the illustrated number.

When the linear multiple regression model shown in FIG. 7 is applied to the relation between the current and the voltage, for example, a current actual result is input to the input variables x₁ to x₃, and, for example, a voltage command is obtained as the output y₁. For example, a physical constant is set in the weight values w₁ to w₄ of each node. The types of the physical constant set in the weight values w₁ to w₄ are selected according to the physical quantity to be analyzed. For example, when the current actual result of the motor is defined as the input and the voltage command is defined as the output, the physical constants such as a motor resistance value (R), a d-axis inductance (Ld), a q-axis inductance (Lq), a back electromotive force constant (Ke), a torque constant (Kt), a viscous friction (Dm), and an inertia (J) can be assigned to each node, and the weight values can be set.

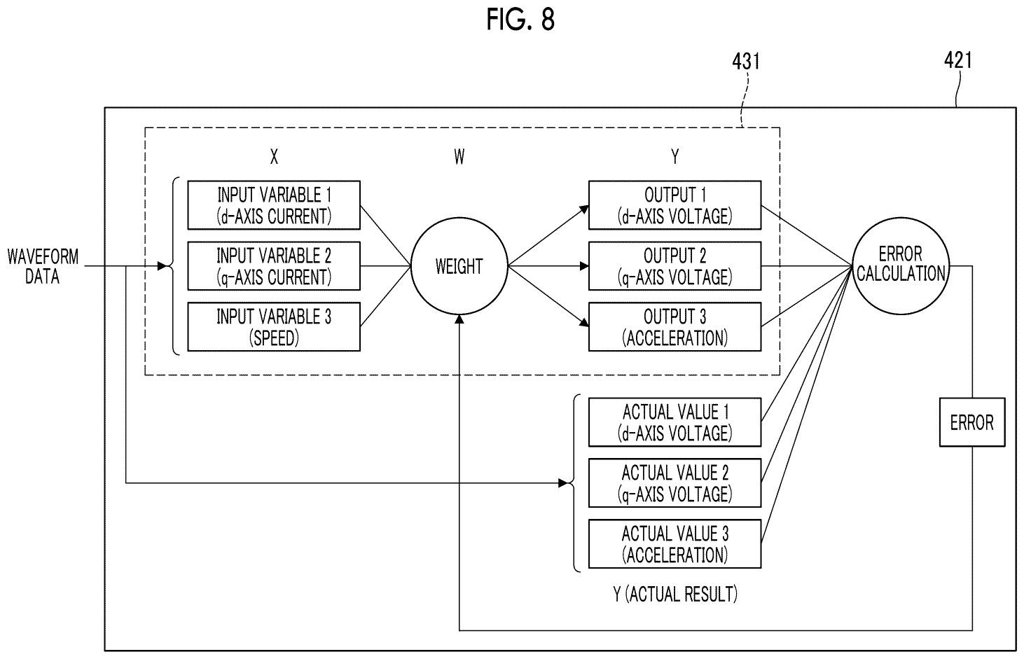

FIG. 8 is a diagram showing an example of an analysis process performed by the analysis unit 421. The analysis unit 421 analyzes the waveform data acquired from the injection molding machine 10, which is the control target equipment, by using the supervised learning using the machine learning model 431 (linear multiple regression model) described with reference to FIG. 7, and specifies the characteristics of the equipment. A format of the waveform data is not particularly limited. For example, the data in which the value is listed through the CSV or the like may be used, or a waveform diagram may be used. Here, as an example, the machine learning model 431 is a model for obtaining a voltage and an acceleration from a current actual result and a speed actual result of the motor. In FIG. 8, the intermediate layers of the machine learning model 431 are described as being aggregated into one node.

The analysis unit 421 extracts a d-axis current, a q-axis current, and a speed as the input variables X from the waveform data acquired from the injection molding machine 10 and inputs the input variables X to the machine learning model 431. In addition, the analysis unit 421 extracts the actual values (Y (actual results)) of a d-axis voltage, a q-axis voltage, and an acceleration from the input waveform data. These actual values correspond to output contents calculated by the machine learning model 431 based on the d-axis current, the q-axis current, and the speed, which are the input variables.

Meanwhile, the machine learning model 431 derives each of a d-axis voltage, a q-axis voltage, and an acceleration as the outputs (Y) based on the input d-axis current, q-axis current, and speed. Here, the d-axis voltage, the q-axis voltage, and the acceleration are defined based on the d-axis current, the q-axis current, and the speed, respectively.

Next, the analysis unit 421 compares the actual values (Y (actual results)) of the d-axis voltage, the q-axis voltage, and the acceleration extracted from the waveform data with the outputs (Y) of the d-axis voltage, the q-axis voltage, and the acceleration obtained by using the machine learning model 431, and calculates an error. The weight values W of each node in the intermediate layer are corrected such that the error is minimized, in other words, the outputs (Y) of the d-axis voltage, the q-axis voltage, and the acceleration match the actual values (Y (actual results)) of the d-axis voltage, the q-axis voltage, and the acceleration. When the weight values W that minimize the error between the outputs (Y) of the d-axis voltage, the q-axis voltage, and the acceleration and the actual values (Y (actual results)) of the d-axis voltage, the q-axis voltage, and the acceleration are obtained, the weight values W represent the characteristics of the motor of the injection molding machine 10, which is an acquisition source of the input waveform data. The difference in the characteristics in the injection molding machine 10, which is the control target equipment, is an example of a machine difference for each injection molding machine 10.

In the above description, although the analysis unit 421 corrects the weight values W such that the error between the outputs (Y) of the d-axis voltage, the q-axis voltage, and the acceleration and the actual values (Y (actual results)) of the d-axis voltage, the q-axis voltage, and the acceleration is minimized, this is merely an example. For example, instead of the above processing, the analysis unit 421 may correct the weight values W such that the error is smaller than a predetermined threshold. In this case, the outputs (Y) of the d-axis voltage, the q-axis voltage, and the acceleration, which approximate the actual values (Y (actual results)) of the d-axis voltage, the q-axis voltage, and the acceleration, are obtained through an analysis using the machine learning model 431 in which the weight values W are corrected.

In the example of the analysis process shown in FIG. 8, although an example has been described in which an error is calculated by comparing the actual values (Y (actual results)) of the d-axis voltage, the q-axis voltage, and the acceleration extracted from the waveform data and the outputs (Y) of the d-axis voltage, the q-axis voltage, and the acceleration obtained by using the machine learning model 431, these variables are not limited to the above example, and comparisons and error calculations may be performed using other variables that have a causal relationship. For example, instead of the actual value and output of the acceleration, a value obtained by using a time differential of the speed, an approximate calculation formula, or the like may be used. In addition, instead of the actual value and output of the voltage, a value of a duty (a ratio of ON to OFF) of an inverter may be used. In addition, as the speed in the input, instead of the speed data directly obtained by the sensor, or the like, a speed value calculated from the difference in position data of an encoder may be used. In addition, instead of the current actual result, a voltage value output from a current detector may be used as an input.

### Adjustment of Characteristics of Control Target Equipment

The processing unit 420 of the information processing device 400 generates information (hereinafter, referred to as “characteristic adjustment information”) for performing control to reduce the machine difference between the injection molding machine 10 and the other injection molding machines, based on the information on the characteristics of the injection molding machine 10 obtained as described above. As an example of such characteristic adjustment information, the processing unit 420 may generate a gain for correcting the control information used in controlling the injection unit 20 and the mold clamping unit 30 via the control device 100. The gain is a coefficient multiplied by a value used as the control information to compensate for deviations based on the characteristics of the injection molding machine 10. The control device 100 corrects the control information by using the gain acquired from the information processing device 400 and controls the injection unit 20 and the mold clamping unit 30. In this way, since there is no need to change the design of the control information, which is included in the control unit 110 of the control device 100, based on the characteristics (weight values W) of the injection molding machine 10 analyzed by the analysis unit 421, and it is only necessary to correct the control information, which is already included in the control unit 110, increase in the scale of the design change can be reduced.

Meanwhile, the processing unit 420 may generate the control information, which is used by the control device 100 to control the injection unit 20 and the mold clamping unit 30, based on the characteristics (weight values W) of the injection molding machine 10 analyzed by the analysis unit 421, as the characteristic adjustment information. The control device 100 replaces the control information, which is included in the control unit 110, with the control information acquired from the information processing device 400 and controls the injection unit 20 and the mold clamping unit 30. In addition, as the characteristic adjustment information, the processing unit 420 may transmit the information on the characteristics (weight values W) of the injection molding machine 10 analyzed by the analysis unit 421 to the control device 100 as is. In this case, the control device 100 generates the gain and corrects the control information, or generates the control information reflecting the characteristics, based on the information on the characteristics of the injection molding machine 10 acquired from the information processing device 400.

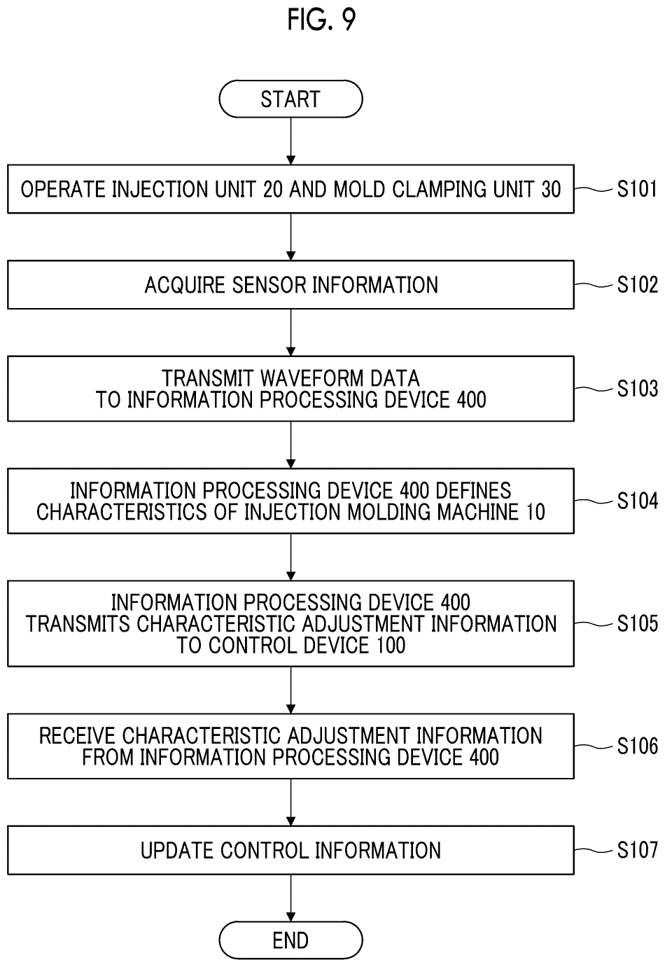

FIG. 9 is a flowchart showing a procedure for adjusting the control information according to the characteristics of equipment in the injection molding machine 10. First, in the injection molding machine 10, the control device 100 operates the injection unit 20 and the mold clamping unit 30 (S101), and the data processing device 200 acquires sensor information detected in accordance with the operations of the injection unit 20 and the mold clamping unit 30 (S102). The control device 100 and the data processing device 200 transmit the waveform data, which is obtained through the operations of the injection unit 20 and the mold clamping unit 30, to the information processing device 400 (S103).

The information processing device 400 defines the characteristics of the injection molding machine 10 by analyzing the waveform data received from the control device 100 and the data processing device 200 (S104) and transmits the characteristic adjustment information, which is based on the obtained characteristics, to the control device 100 of the injection molding machine 10 (S105). When the control device 100 receives the characteristic adjustment information from the information processing device 400 (S106), the control device 100 adjusts the control information for controlling the injection unit 20 and the mold clamping unit 30, based on the received characteristic adjustment information (S107). Thereafter, the control device 100 of the injection molding machine 10 controls the injection unit 20 and the mold clamping unit 30 by using the control information adjusted to reflect the unique characteristics for each equipment. In addition, by changing the control performed by the control device 100 and performing the control in accordance with the characteristics of the equipment, the machine difference in equipment control with other equipment is reduced.

Although the embodiments of the present invention have been described above, the technical scope of the present invention is not limited to the above-described embodiments. For example, in the above-described embodiment, the information processing device 400 connected to the injection molding machine 10 analyzes the waveform data and generates the characteristic adjustment information. However, the data processing device 200 of the injection molding machine 10 may analyze the waveform data and generate the characteristic adjustment information.

In addition, in the above-described embodiment, although a description is made in which the machine difference for each equipment is reduced, the present embodiment can also be applied to the case where the characteristics of the same equipment are changed based on differences in operating environment, or the like. For example, the injection molding machine 10 is affected by a change in the type of resin that is a molding material, a change in the die, a change in the outside air temperature, or the like, and the characteristics thereof are changed. Therefore, the waveform data may be acquired in response to changes or fluctuations in these environments, the characteristics of the equipment in each environment may be specified, and control according to the characteristics may be performed.

In addition, when a gain in the control is generated as equipment adjustment information, the present embodiment can be widely applied to gains for which a design method has been established in control engineering, such as a proportional gain and an integral gain in PI control of a current, a speed, a pressure, and the like, a coefficient of a noise filter, and a gain of feedforward. In addition, various changes or alternatives in the configuration that do not depart from the scope of the technical thought of the present invention are included in the present invention.

It should be understood that the invention is not limited to the above-described embodiment, but may be modified into various forms on the basis of the spirit of the invention. Additionally, the modifications are included in the scope of the invention.

What is claimed is:

1. An information processing system comprising:
an acquisition unit that acquires waveform data obtained through an operation of control target equipment;
an analysis unit that extracts, based on a relationship of variables included in the acquired waveform data, a first variable that is at least a portion of the variables and a second variable that is at least another portion of the variables, that derives variables corresponding to the second variables based on the first variable, and that defines characteristics of the control target equipment based on the derived variables and the second variable; and
an output unit that outputs information used in controlling the control target equipment based on the characteristics of the control target equipment.

2. The information processing system according to claim 1, wherein
the analysis unit inputs a plurality of the first variables, uses a linear multiple regression model for obtaining one output through a plurality of processes in an intermediate layer, and derives the variable corresponding to the second variable as the output.

3. The information processing system according to claim 2, wherein
the analysis unit corrects weight values set for the plurality of processes in the intermediate layer such that an error between the derived variable and the second variable is small and uses the corrected weight values as information representing the characteristics of the control target equipment.

4. The information processing system according to claim 3, wherein
the information, which is output from the output unit, is information on a gain in controlling the control target equipment, which is generated based on the corrected weight value.

5. A non-transitory computer readable medium storing a program that causes a computer to function as:
a unit of acquiring waveform data obtained through an operation of control target equipment;
a unit of extracting, based on a relationship of variables included in the acquired waveform data, a first variable that is at least a portion of the variables and a second variable that is at least another portion of the variables, of deriving variables corresponding to the second variables based on the first variable, and of defining characteristics of the control target equipment based on the derived variables and the second variable; and
a unit of outputting information used in controlling the control target equipment based on the characteristics of the control target equipment.

6. A manufacturing method of an injection molding machine comprising:
a step of acquiring waveform data by operating the injection molding machine;
a step of extracting, based on a relationship of variables included in the acquired waveform data, a first variable that is at least a portion of the variables and a second variable that is at least another portion of the variables, of deriving variables corresponding to the second variables based on the first variable, and of defining characteristics of the injection molding machine based on the derived variables and the second variable; and
a step of adjusting control information of the injection molding machine based on the characteristics of the injection molding machine.
